(19) United States
(12) Patent Application Publication
(10) Pub. No.: US 2026/0051255 A1
(43) Pub. Date: Feb. 19, 2026

(54) SYSTEMS, APPARATUSES, METHODS, AND COMPUTER PROGRAM PRODUCTS FOR AVIATION FEATURE OPERATIONS

(71) Applicant: Honeywell International Inc., Charlotte, NC (US)

(72) Inventors: Sreenivasan Govindillam, Bangalore (IN); Nathan Krishnamoorthy, Bangalore (IN); Sri Harsha Kosuri, Bangalore (IN); Ranjani Tumkur Venkataramaiah, Bangalore (IN)

(21) Appl. No.: 18/902,240

(22) Filed: Sep. 30, 2024

(30) Foreign Application Priority Data
Aug. 16, 2024 (IN) 202411062089

(51) Int. Cl. G08G 5/00; B64C 19/02; G08G 5/06

(52) U.S. Cl. CPC G08G 5/20; B64C 19/02; G08G 5/21; G08G 5/34; G08G 5/51

(57) ABSTRACT

Systems, apparatuses, methods, and computer program products are provided herein. For example, a method is described herein includes identifying aviation operations program data representative of one or more aviation operations programs. In some embodiments, the method includes configuring the one or more aviation operations programs in accordance with at least one of a plurality of aviation implementation states. In some embodiments, the method includes providing aviation mission data to an external aviation mission device. In some embodiments, the method includes receiving, from the external aviation mission device, first program implementation data in response to an aviation mission activation event. In some embodiments, the method includes initiating performance of one or more aviation mission actions based on the first program implementation data.

### CROSS REFERENCE TO RELATED APPLICATIONS

This application claims the benefit of India Provisional Application No. 202411062089 filed August 16, 2024, and entitled “SYSTEMS, APPARATUSES, METHODS, AND COMPUTER PROGRAM PRODUCTS FOR AVIATION FEATURE OPERATIONS,” which is hereby incorporated by reference in its entirety.

### TECHNOLOGICAL FIELD

Embodiments of the present disclosure relate generally to systems, apparatuses, methods, and computer program products for initiating performance one or more aviation mission actions.

### BACKGROUND

Applicant has identified many technical challenges and difficulties associated with initiating performance one or more aviation mission actions. Through applied effort, ingenuity, and innovation, Applicant has solved problems related to initiating performance one or more aviation mission actions by developing solutions embodied in the present disclosure, which are described in detail below.

### BRIEF SUMMARY

Various embodiments described herein relate to systems, apparatuses, methods, and computer program products for initiating performance of one or more aviation mission actions.

In accordance with one aspect of the disclosure, a system is provided. In some embodiments, the system includes an onboard aviation mission device comprising memory and one or more processors communicatively coupled to the memory. In some embodiments, the one or more processors are configured to identify aviation operations program data representative of one or more aviation operations programs. In some embodiments, the one or more processors are configured to configure the one or more aviation operations programs in accordance with at least one of a plurality of aviation implementation states. In some embodiments, a first aviation operations program of the one or more aviation operations programs is configured in accordance with an armed aviation implementation state of the plurality of aviation implementation states. In some embodiments, the one or more processors are configured to provide aviation mission data to an external aviation mission device. In some embodiments, the one or more processors are configured to receive, from the external aviation mission device, first program implementation data in response to an aviation mission activation event. In some embodiments, the one or more processors are configured to initiate performance of one or more aviation mission actions based on the first program implementation data.

In some embodiments, a second aviation operations program of the one or more aviation operations programs is configured in accordance with an active aviation implementation state of the plurality of aviation implementation states.

In some embodiments, the one or more processors are configured to receive, from the external aviation mission device, second program implementation data.

In some embodiments, the one or more processors are configured to initiate performance of one or more aviation mission actions based on the second program implementation data.

In some embodiments, a third aviation operations program of the one or more aviation operations programs is configured in accordance with a cancelled aviation implementation state of the plurality of aviation implementation states.

In some embodiments, the one or more processors are configured to transmit a cancelled aviation implementation state indication to the external aviation mission device.

In some embodiments, a third aviation operations program of the one or more aviation operations programs is configured in accordance with an inactive aviation implementation state of the plurality of aviation implementation states.

In some embodiments, the one or more processors are configured to transmit an inactive aviation implementation state indication to the external aviation mission device.

In some embodiments, initiating performance of one or more aviation mission actions based on the first program implementation data includes the one or more processors being further configured to cause actuation of one or more aircraft components associated with an aircraft.

In some embodiments, initiating performance of one or more aviation mission actions based on the first program implementation data includes the one or more processors being further configured to modify an aviation mission.

In some embodiments, the one or more processors are configured to configure at least one of the one or more aviation operations programs in accordance with at least one of a plurality of aviation activation states.

In some embodiments, the plurality of aviation activation states comprises a primary aviation activation state.

In some embodiments, the plurality of aviation activation states comprises a primary aviation activation state.

In some embodiments, the system further includes the external aviation mission device. In some embodiments, the external aviation mission device comprises second memory and one or more second processors communicatively coupled to the second memory.

In some embodiments, the one or more second processors are configured to receive the aviation mission data from the onboard aviation mission device.

In some embodiments, the one or more second processors are configured to identify the aviation mission activation event.

In some embodiments, the one or more second processors are configured to generate the first program implementation data by applying the aviation mission data to the first aviation operations program.

In some embodiments, the one or more second processors are configured to provide the first program implementation data to the onboard aviation mission device.

In some embodiments, the one or more second processors are configured to receive the aviation mission data from the onboard aviation mission device.

In some embodiments, the one or more second processors are configured to generate the second program implementation data by applying the aviation mission data to the second aviation operations program.

In some embodiments, the one or more second processors are configured to provide the second program implementation data to the onboard aviation mission device.

In some embodiments, the one or more processors are configured to generate one or more of an aviation operations program interface component, an aviation operations program implementation interface component, or an aviation operations program activation interface component.

In accordance with one aspect of the disclosure, a method is provided. In some embodiments, the method includes identifying aviation operations program data representative of one or more aviation operations programs. In some embodiments, the method includes configuring the one or more aviation operations programs in accordance with at least one of a plurality of aviation implementation states. In some embodiments, a first aviation operations program of the one or more aviation operations programs is configured in accordance with an armed aviation implementation state of the plurality of aviation implementation states. In some embodiments, the method includes providing aviation mission data to an external aviation mission device. In some embodiments, the method includes receiving, from the external aviation mission device, first program implementation data in response to an aviation mission activation event. In some embodiments, the method includes initiating performance of one or more aviation mission actions based on the first program implementation data.

In some embodiments, a second aviation operations program of the one or more aviation operations programs is configured in accordance with an active aviation implementation state of the plurality of aviation implementation states.

In some embodiments, a third aviation operations program of the one or more aviation operations programs is configured in accordance with a cancelled aviation implementation state of the plurality of aviation implementation states.

In some embodiments, a fourth aviation operations program of the one or more aviation operations programs is configured in accordance with an inactive aviation implementation state of the plurality of aviation implementation states.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying aviation operations program data representative of one or more aviation operations programs. In some embodiments, the computer program code, in execution with at least one processor, configures the computer program product for configuring the one or more aviation operations programs in accordance with at least one of a plurality of aviation implementation states. In some embodiments, a first aviation operations program of the one or more aviation operations programs is configured in accordance with an armed aviation implementation state of the plurality of aviation implementation states. In some embodiments, the computer program code, in execution with at least one processor, configures the computer program product for providing aviation mission data to an external aviation mission device. In some embodiments, the computer program code, in execution with at least one processor, configures the computer program product for receiving, from the external aviation mission device, first program implementation data in response to an aviation mission activation event. In some embodiments, the computer program code, in execution with at least one processor, configures the computer program product for initiating performance of one or more aviation mission actions based on the first program implementation data.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example interface component in accordance with one or more embodiments of the present disclosure;

FIG. 4 illustrates an example interface component in accordance with one or more embodiments of the present disclosure;

FIG. 5 illustrates an example interface component in accordance with one or more embodiments of the present disclosure;

FIG. 6 illustrates a flowchart of an example method in accordance with one or more embodiments of the present disclosure;

FIG. 7 illustrates a flowchart of an example method in accordance with one or more embodiments of the present disclosure;

FIG. 8 illustrates a flowchart of an example method in accordance with one or more embodiments of the present disclosure; and

FIG. 9 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### OVERVIEW

Example embodiments disclosed herein address technical problems associated with initiating performance of one or more aviation mission actions. As would be understood by one skilled in the field to which this disclosure pertains, there are numerous example scenarios in which it may be desirable to initiate performance of one or more aviation mission actions.

In many applications, systems, apparatuses, methods, and computer program products for initiating performance of one or more aviation mission actions are desirable. For example, it may be desirable to initiate performance of one or more aviation mission actions when an aircraft is at an airport. As another example, it may be desirable to initiate performance of one or more aviation mission actions when an aircraft is in flight. As another example, it may be desirable to initiate performance of one or more aviation missions using program implementation data generated using one or more aviation operations programs (e.g., one or more aviation features). In some implementations, it may be desirable to initiate performance of one or more aviation missions using program implementation data generated using one or more aviation operations programs (e.g., aviation features) that are configured in accordance with one or more of a plurality of aviation implementation states. In this way, an aircraft is able to efficiently, reliably, and safely perform an aviation mission.

Example solutions for initiating performance of one or more aviation mission actions include using a computing device to initiate performance of one or more aviation mission actions. However, such example solutions are simplistic, inefficient, and static. For example, such example solutions are simplistic because such example solutions do not leverage aviation mission data identified by an onboard aviation mission device (e.g., a flight management system) to generate program implementation data that is generated using aviation operations programs executed by an external aviation mission device (e.g., an electronic flight bag and/or a cloud-based device). As a result, such example solutions are only able to implement simplistic aviation mission actions that do not factor in the real-time operations of an aircraft and/or use the processing power provided by an external aviation mission device. As another example, such example solutions are inefficient because such example solutions do not contemplate configuring aviation operations programs based on one or more aviation implementation states, such as an armed aviation implementation state. As a result, such example solutions have to perform repetitive and duplicate processing in order to initiate performance of one or more aviation mission actions, which increases processing load and memory consumption. As another example, such example solutions are static because such example solutions do not enable configuration of aviation operation programs in accordance with one of a plurality of aviation activation states. As a result, such example solutions are unable to dynamically implement a variety of aviation mission actions based on the desired outcome of the action and/or the state of an aircraft.

Thus, to address these and/or other issues related to such example solutions, example systems, apparatuses, methods, and computer program products for initiating performance of one or more aviation mission actions are disclosed herein. For example, an embodiment, in this disclosure, described in greater detail below, includes a system that includes an onboard aviation mission device and an external aviation mission device. In some embodiments, the onboard aviation mission device is configured to identify aviation operations program data representative of one or more aviation operations programs. In some embodiments, the onboard aviation mission device is configured to configure the one or more aviation operations programs in accordance with at least one of a plurality of aviation implementation states. In some embodiments, a first aviation operations program of the one or more aviation operations programs is configured in accordance with an armed aviation implementation state of the plurality of aviation implementation states. In some embodiments, the onboard aviation mission device is configured to provide aviation mission data to an external aviation mission device. In some embodiments, the onboard aviation mission device is configured to receive, from the external aviation mission device, first program implementation data in response to an aviation mission activation event. In some embodiments, the onboard aviation mission device is configured to initiate performance of one or more aviation mission actions based on the first program implementation data. In some embodiments, the external aviation mission device is configured to generate the first program implementation data by applying the aviation mission data to the first aviation operations program. Accordingly, the systems, apparatuses, methods, and computer program products disclosed herein enable initiating performance of one or more aviation mission actions that operate in an efficient, sophisticated, and dynamic manner.

### EXAMPLE SYSTEMS AND APPARATUSES

Embodiments of the present disclosure herein include systems, apparatuses, methods, and computer program products configured for initiating performance of one or more aviation mission actions. It should be readily appreciated that the embodiments of the apparatus, systems, methods, and computer program product described herein may be configured in various additional and alternative manners in addition to those expressly described herein.

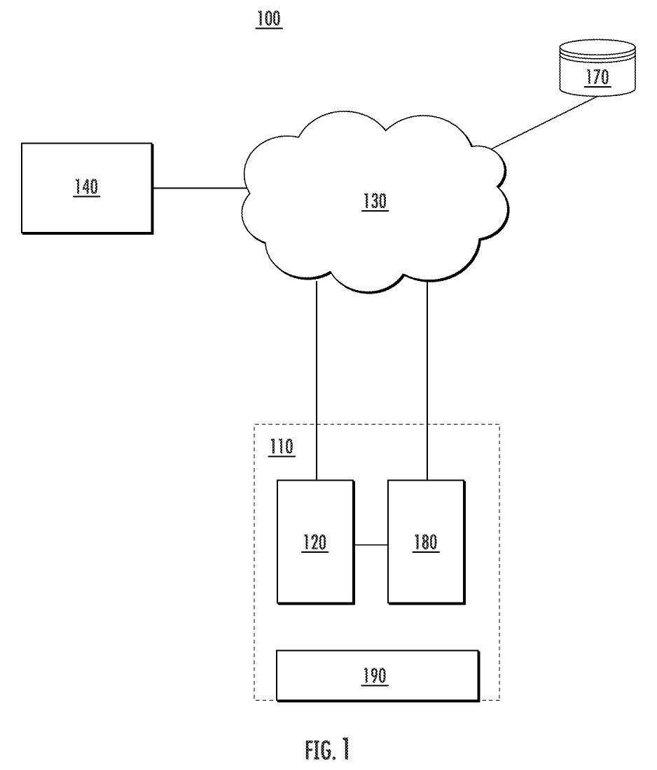

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, drones, and/or the like. In some embodiments, the aircraft 110 is not limited to the examples listed herein and may include other types of transportation device.

In some embodiments, the aircraft 110 is configured to perform an aviation mission. In some embodiments, an aviation mission is a defined series of operations performed by the aircraft 110. For example, may include a defined series of operations performed by the aircraft 110 to move from a first airport to a second airport. In this regard, in some embodiments, an aviation mission may include a defined series of operations performed by the aircraft 110 that include operations performed while the aircraft 110 is performing preflight procedures (e.g., at the gate before a flight), leaving a gate, taxiing, taking off, in flight, landing, parking at a gate performing post flight procedures (e.g., at the gate after a flight), and/or the like. For example, an aviation mission may include a defined series of operations that includes leaving the gate at a first airport, taxiing to a runway at the first airport (e.g., an originating airport), taking off from the first airport, flying to a second airport (e.g., a destination airport), landing at the second airport, taxiing to a gate at the second airport, parking at a gate at the second airport.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the environment 100 includes a cloud-based aviation mission device 140. In some embodiments, the cloud-based aviation mission device 140 is electronically and/or communicatively coupled to the aircraft 110, a mobile aviation mission device 120, an onboard aviation mission device 180, one or more aircraft components 190, and/or one or more databases 170. The cloud-based aviation mission device 140 may be located remotely from the aircraft 110. In this regard, for example, the cloud-based aviation mission device 140 may be located in a remote cloud server and electronically and/or communicatively coupled to the aircraft 110, the mobile aviation mission device 120, the onboard aviation mission device 180, the one or more aircraft components 190, and/or the one or more databases 170 via at least the network 130. In some embodiments, the cloud-based aviation mission device 140 is configured via hardware, software, firmware, and/or a combination thereof, to perform data intake of one or more types of data, such as aviation operations program data, aviation mission data, first program implementation data, second program implementation data, and/or the like.

Additionally, or alternatively, in some embodiments, the cloud-based aviation mission device 140 is configured via hardware, software, firmware, and/or a combination thereof, to generate and/or transmit command(s) that control, adjust, or otherwise impact operations of one or more of the aircraft 110, the mobile aviation mission device 120, the onboard aviation mission device 180, the one or more aircraft components 190, and/or the one or more databases 170. For example, the cloud-based aviation mission device 140 may be configured for initiating performance of one or more aviation mission actions. Additionally, or alternatively, in some embodiments, the cloud-based aviation mission device 140 is configured via hardware, software, firmware, and/or a combination thereof, to perform data reporting, provide data, and/or other data output process(es) associated with monitoring or otherwise analyzing operations of one or more of the aircraft 110, the mobile aviation mission device 120, the onboard aviation mission device 180, the one or more aircraft components 190, and/or the one or more databases 170. For example, in various embodiments, the cloud-based aviation mission device 140 may be configured to execute and/or perform one or more operations and/or functions described herein.

In some embodiments, the environment 100 includes the mobile aviation mission device 120. In some embodiments, the mobile aviation mission device 120 is electronically and/or communicatively coupled to the aircraft 110, the cloud-based aviation mission device 140, the onboard aviation mission device 180, the one or more aircraft components 190, and/or the one or more databases 170. The mobile aviation mission device 120 may be located remotely from the aircraft 110, in proximity of the aircraft 110 (e.g., with a pilot at an airport gate associated with the aircraft 110), and/or within the aircraft 110 (e.g., with the pilot in the aircraft 110). In this regard, for example, the mobile aviation mission device 120 may be portable. In some embodiments, the mobile aviation mission device 120 is an electronic flight bag. In some embodiments, the mobile aviation mission device 120 is configured via hardware, software, firmware, and/or a combination thereof, to perform data intake of one or more types of data, such aviation operations program data, aviation mission data, first program implementation data, second program implementation data, and/or the like.

Additionally, or alternatively, in some embodiments, the mobile aviation mission device 120 is configured via hardware, software, firmware, and/or a combination thereof, to generate and/or transmit command(s) that control, adjust, or otherwise impact operations of one or more of the aircraft 110, the cloud-based aviation mission device 140, the onboard aviation mission device 180, the one or more aircraft components 190, and/or the one or more databases 170. For example, the mobile aviation mission device 120 may be configured for initiating performance of one or more aviation mission actions. Additionally, or alternatively, in some embodiments, the mobile aviation mission device 120 is configured via hardware, software, firmware, and/or a combination thereof, to perform data reporting, provide data, and/or other data output process(es) associated with monitoring or otherwise analyzing operations of one or more of the aircraft 110, the cloud-based aviation mission device 140, the onboard aviation mission device 180, the one or more aircraft components 190, and/or the one or more databases 170. For example, in various embodiments, the mobile aviation mission device 120 may be configured to execute and/or perform one or more operations and/or functions described herein.

In some embodiments, the environment 100 includes the onboard aviation mission device 180. In some embodiments, the onboard aviation mission device 180 is electronically and/or communicatively coupled to the aircraft 110, the cloud-based aviation mission device 140, the mobile aviation mission device 120, the one or more aircraft components 190, and/or the one or more databases 170. The onboard aviation mission device 180 may be located within the aircraft 110 (e.g., as a component of the aircraft 110). In this regard, for example, the onboard aviation mission device 180 may physically secured to the aircraft 110. In some embodiments, the onboard aviation mission device 180 may comprise a flight management system (FMS). In some embodiments, the onboard aviation mission device 180 is configured via hardware, software, firmware, and/or a combination thereof, to perform data intake of one or more types of data, such as aviation operations program data, aviation mission data, first program implementation data, second program implementation data, and/or the like.

Additionally, or alternatively, in some embodiments, the onboard aviation mission device 180 is configured via hardware, software, firmware, and/or a combination thereof, to generate and/or transmit command(s) that control, adjust, or otherwise impact operations of one or more of the aircraft 110, the cloud-based aviation mission device 140, the mobile aviation mission device 120, the one or more aircraft components 190, and/or the one or more databases 170. For example, the onboard aviation mission device 180 may be configured for initiating performance of one or more aviation mission actions. Additionally, or alternatively, in some embodiments, the onboard aviation mission device 180 is configured via hardware, software, firmware, and/or a combination thereof, to perform data reporting, provide data, and/or other data output process(es) associated with monitoring or otherwise analyzing operations of one or more of the aircraft 110, the cloud-based aviation mission device 140, the mobile aviation mission device 120, the one or more aircraft components 190, and/or the one or more databases 170. For example, in various embodiments, the onboard aviation mission device 180 may be configured to execute and/or perform one or more operations and/or functions described herein.

In some embodiments, the environment 100 includes the one or more aircraft components 190. In some embodiments, the one or more aircraft components 190 are electronically and/or communicatively coupled to the aircraft 110, the cloud-based aviation mission device 140, the mobile aviation mission device 120, the onboard aviation mission device 180, and/or the one or more databases 170. The one or more aircraft components 190 may be located within the aircraft 110. In this regard, for example may be one or more individual components of the aircraft 110 that perform a particular function during operation of the aircraft 110. For example, the one or more aircraft components 190 may include one or more of multi-function control and display units (MCDU), flight management systems (FMS) (e.g., a secondary flight management system when the onboard aviation mission device 180 is a flight management system), inertial reference systems (IRS), global positioning systems (GPS), sensors, actuators, primary flight displays, radars (e.g., weather radars), engines, auxiliary power units (APU), enhanced ground proximity warning systems (EGPWS), landing gear, flaps, power stations, ailerons, autopilot systems, empennages, and/or the like. In this regard, for example, the individual components of the aircraft 110 may include components associated with a particular process or operation performed by the aircraft 110. In some embodiments, the one or more aircraft components 190 are physically secured to the aircraft 110. In some embodiments, the one or more aircraft components 190 include the onboard aviation mission device 180. In some embodiments, the one or more aircraft components 190 are configured via hardware, software, firmware, and/or a combination thereof, to perform data intake of one or more types of data, such as aviation operations program data, aviation mission data, first program implementation data, second program implementation data, and/or the like.

Additionally, or alternatively, in some embodiments, the one or more aircraft components 190 are configured via hardware, software, firmware, and/or a combination thereof, to generate and/or transmit command(s) that control, adjust, or otherwise impact operations of one or more of the aircraft 110, the cloud-based aviation mission device 140, the mobile aviation mission device 120, the onboard aviation mission device 180, and/or the one or more databases 170. For example, the one or more aircraft components 190 may be configured for initiating performance of one or more aviation mission actions. Additionally, or alternatively, in some embodiments, the one or more aircraft components 190 are configured via hardware, software, firmware, and/or a combination thereof, to perform data reporting, provide data, and/or other data output process(es) associated with monitoring or otherwise analyzing operations of one or more of the aircraft 110, the cloud-based aviation mission device 140, the mobile aviation mission device 120, the onboard aviation mission device 180, and/or the one or more databases 170. For example, in various embodiments, the one or more aircraft components 190 may be configured to execute and/or perform one or more operations and/or functions described herein.

In some embodiments, the environment 100 includes an external aviation mission device. In some embodiments, the external aviation mission device is at least partially embodied by cloud-based aviation mission device 140. Additionally, or alternatively, the external aviation mission device is at least partially embodied by the mobile aviation mission device 120.

In some embodiments, the environment 100 includes the one or more databases 170. The one or more databases 170 may be configured to receive, store, and/or transmit data. For example, the one or more databases 170 may be configured to receive, store, and/or transmit data associated with the aircraft 110, the cloud-based aviation mission device 140, the mobile aviation mission device 120, the one or more databases 170, the one or more aircraft components 190, and/or the onboard aviation mission device 180. In this regard, for example, the one or more databases 170 may be configured to receive, store, and/or transmit data such as aviation operations program data, aviation mission data, first program implementation data, second program implementation data, and/or the like. The one or more databases 170 may be located remotely from the aircraft 110, in proximity of the aircraft 110, and/or within the aircraft 110.

In some embodiments, the environment 100 includes the network 130. The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the cloud-based aviation mission device 140 may include the one or more databases 170.

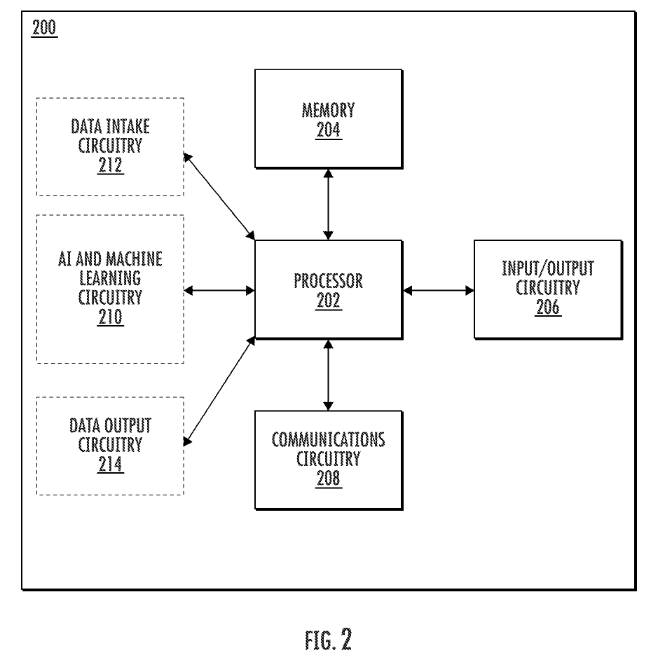

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the aircraft 110, the cloud-based aviation mission device 140, the mobile aviation mission device 120, the one or more databases 170, the one or more aircraft components 190, and/or the onboard aviation mission device 180. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the cloud-based aviation mission device 140, the mobile aviation mission device 120, the one or more databases 170, the one or more aircraft components 190, and/or the onboard aviation mission device 180 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

In some embodiments, the onboard aviation mission device 180 is configured to identify aviation operations program data. In some embodiments, aviation operations program data includes one or more items of data representative and/or indicative of one or more aviation operations programs. In some embodiments, an aviation operations program is an aviation related computing program that when executed generates program implementation data. For example, the one or more aviation operations programs includes one or more optimal altitude programs configured to generate program implementation data. As another example, the one or more aviation operations programs includes one or more landing operations programs configured to generate program implementation data. As another example, the one or more aviation operations programs includes one or more takeoff operations programs configured to generate program implementation data. As another example, the one or more aviation operations programs includes one or more weather impact programs configured to generate program implementation data. As another example, the one or more aviation operations programs includes one or more fuel operations programs configured to generate program implementation data.

In some embodiments, identifying aviation operations program data includes the onboard aviation mission device 180 being configured to receive aviation operations program data. In some embodiments, the onboard aviation mission device 180 is configured to receive aviation operations program data from the external aviation mission device (e.g., the cloud-based aviation mission device 140 and/or the mobile aviation mission device 120). In some embodiments, the onboard aviation mission device 180 is configured to receive aviation operations program data from the external aviation mission device (e.g., the cloud-based aviation mission device 140 and/or the mobile aviation mission device 120) in response to a query from the onboard aviation mission device 180.

In some embodiments, the onboard aviation mission device 180 is configured to configure at least one of the one or more aviation operations programs in accordance with at least one of a plurality of aviation implementation states. In some embodiments, the plurality of aviation implementation states includes an armed aviation implementation state. In this regard, in some embodiments, the onboard aviation mission device 180 is configured to configure a first aviation operations program of the plurality of aviation operations programs in accordance with an armed aviation implementation state.

In some embodiments, an aviation operations program configured in accordance with an armed aviation implementation state corresponds to an aviation operations program (e.g., the first aviation operations program) that is configured to be executed upon occurrence of an aviation mission activation event. Said differently, for example, an aviation operations program configured in accordance with an armed aviation implementation state corresponds to an aviation operations program that is not currently needed for the aircraft 110 to perform an aviation mission but will be needed at a future point in the aviation mission. For example, an aviation operations program configured in accordance with an armed aviation implementation state may correspond to landing operations program for the aircraft 110 when the aircraft 110 is in flight but has not yet been assigned a runway for landing at a destination airport.

In some embodiments, the plurality of aviation implementation states includes an active aviation implementation state. In this regard, in some embodiments, the onboard aviation mission device 180 is configured to configure a second aviation operations program of the plurality of aviation operations programs in accordance with an active aviation implementation state. In some embodiments, an aviation operations program configured in accordance with an active aviation implementation state corresponds to an aviation operations program (e.g., the second aviation operations program) that is configured to be executed upon being configured. Said differently, for example, an aviation operations program configured in accordance with an active aviation implementation state corresponds to an aviation operations program that is currently needed for the aircraft 110 to perform an aviation mission such that the aviation operations program is executed upon being configured in accordance with an active aviation implementation state. For example, an aviation operations program configured in accordance with an active aviation implementation state may correspond to optimal altitude program for the aircraft 110 when the aircraft 110 is in flight.

In some embodiments, the plurality of aviation implementation states includes a cancelled aviation implementation state. In this regard, in some embodiments, the onboard aviation mission device 180 is configured to configure a third aviation operations program of the plurality of aviation operations programs in accordance with a cancelled aviation implementation state. In some embodiments, an aviation operations program configured in accordance with a cancelled aviation implementation state corresponds to an aviation operations program (e.g., the third aviation operations program) that is not needed to perform an aviation mission. For example, an aviation operations program configured in accordance with a cancelled aviation implementation state may correspond to optimal altitude program for the aircraft 110 when the altitude of the aircraft 110 is being directed by an air traffic controller (ATC).

In some embodiments, the plurality of aviation implementation states includes an inactive aviation implementation state. In this regard, in some embodiments, the onboard aviation mission device 180 is configured to configure a fourth aviation operations program of the plurality of aviation operations programs in accordance with an inactive aviation implementation state. In some embodiments, an aviation operations program (e.g., the fourth aviation operations program) configured in accordance with an inactive aviation implementation state corresponds to an aviation operations program that that was previously executed during an aviation mission. Said differently, for example, an aviation operations program configured in accordance with an inactive aviation implementation state corresponds to an aviation operations program that was previously executed during an aviation mission and is no longer needed to complete the aviation mission. For example, an aviation operations program configured in accordance with an inactive aviation implementation state may correspond to takeoff operations program for the aircraft when the aircraft 110 has already taken off and is in flight.

In some embodiments, the onboard aviation mission device 180 is configured to transmit a cancelled aviation implementation state indication. In some embodiments, a cancelled aviation implementation state indication is configured to indicate that the third aviation operations program of the one or more aviation operations programs has been configured in accordance with a cancelled aviation implementation state of the plurality of aviation implementation states. In some embodiments, a cancelled aviation implementation state indication may be transmitted from the onboard aviation mission device 180 to the external aviation mission device (e.g., the cloud-based aviation mission device 140 and/or the mobile aviation mission device 120). In some embodiments, a cancelled aviation implementation state indication may be transmitted from the onboard aviation mission device 180 in response to the third aviation operations program being configured in accordance with a cancelled aviation implementation state.

In some embodiments, the onboard aviation mission device 180 is configured to transmit an inactive aviation implementation state indication. In some embodiments, an inactive aviation implementation state indication is configured to indicate that the fourth aviation operations program of the one or more aviation operations programs has been configured in accordance with an inactive aviation implementation state of the plurality of aviation implementation states. In some embodiments, an inactive aviation implementation state indication may be transmitted from the onboard aviation mission device 180 to the external aviation mission device (e.g., the cloud-based aviation mission device 140 and/or the mobile aviation mission device 120). In some embodiments, an inactive aviation implementation state indication may be transmitted from the onboard aviation mission device 180 in response to the fourth aviation operations program being configured in accordance with an inactive aviation implementation state.

In some embodiments, the onboard aviation mission device 180 is configured to identify aviation mission data. In some embodiments, aviation mission data includes one or more items of data representative and/or indicative of operations of the aircraft 110. For example, aviation mission data may include one or more items of data representative and/or indicative of engine performance of the aircraft 110. As another example, aviation mission data may include one or more items of data representative and/or indicative of fuel consumption of the aircraft 110. As another example, aviation mission data may include one or more items of data representative and/or indicative of weather in proximity to the aircraft 110 and/or weather along a flight path used by the aircraft 110 to complete an aviation mission (e.g., weather information provided by an originating airport). As another example, aviation mission data may include one or more items of data representative and/or indicative of a flight path of the aircraft 110.

As another example, aviation mission data may include one or more items of data representative and/or indicative of an altitude associated with the aircraft 110. As another example, aviation mission data may include one or more items of data representative and/or indicative of a heading associated with the aircraft 110. As another example, aviation mission data may include one or more items of data representative and/or indicative of a speed associated with the aircraft 110. As another example, aviation mission data may include one or more items of data representative and/or indicative of a position of the aircraft 110. As another example, aviation mission data may include one or more items of data representative and/or indicative of aircraft traffic in proximity to the aircraft and/or aircraft traffic along a flight path used by the aircraft 110 to complete an aviation mission. As another example, aviation mission data may include one or more items of data representative and/or indicative of a takeoff runway associated with the aircraft 110 (e.g., at an originating airport).

As another example, aviation mission data may include one or more items of data representative and/or indicative of a landing runway associated with the aircraft 110 (e.g., at a destination airport). As another example, aviation mission data may include one or more items of data representative and/or indicative of taxiways associated with the aircraft 110 (e.g., at an originating airport and/or at a destination airport). As another example, aviation mission data may include one or more items of data representative and/or indicative of a flight time associated with the aircraft 110. As another example, aviation mission data may include one or more items of data representative and/or indicative of a time of arrival associated with the aircraft 110. As another example, aviation mission data may include one or more items of data representative and/or indicative of a flight plan associated with the aircraft 110.

In some embodiments, identifying aviation mission data includes the onboard aviation mission device 180 being configured to receive aviation mission data. For example, the onboard aviation mission device 180 may be configured to receive aviation mission data from the one or more aircraft components 190. As another example, the onboard aviation mission device 180 may be configured to receive aviation mission data from an operator (e.g., a pilot) of the aircraft 110. In some embodiments, identifying aviation mission data includes the onboard aviation mission device 180 being configured to generate aviation mission data. For example, the onboard aviation mission device 180 may be configured to generate aviation mission data using the one or more aircraft components 190.

In some embodiments, the onboard aviation mission device 180 is configured to provide aviation mission data. In some embodiments, the onboard aviation mission device 180 is configured to provide aviation mission data to the external aviation mission device (e.g., the cloud-based aviation mission device 140 and/or the mobile aviation mission device 120). In some embodiments, the onboard aviation mission device 180 is configured to provide aviation mission data for each of the one or more aviation operations programs. In some embodiments, the onboard aviation mission device 180 is configured to provide aviation mission data in real-time. In this regard, for example, the onboard aviation mission device 180 may be configured to provide aviation mission data as the onboard aviation mission device 180 identifies the aviation mission data.

In some embodiments, the external aviation mission device (e.g., the cloud-based aviation mission device 140 and/or the mobile aviation mission device 120) is configured to receive a cancelled aviation implementation state indication. In some embodiments, the external aviation mission device is configured to receive a cancelled aviation implementation state indication from the onboard aviation mission device 180. In some embodiments, in response to receiving a cancelled aviation implementation state indication, the external aviation mission device is configured to deactivate and/or disarm at least one of the one or more aviation operations programs. For example, in response to receiving a cancelled aviation implementation state indication, the external aviation mission device is configured to deactivate and/or disarm the third aviation operations program. In this regard, for example, the external aviation mission device (e.g., the cloud-based aviation mission device 140 and/or the mobile aviation mission device 120) and/or the onboard aviation mission device 180 is configured to reduce processing loads and memory consumption by ensuring aviation operations programs that are not needed for the aircraft 110 to complete an aviation mission are not configured in accordance with an active aviation implementation state and/or an armed aviation implementation state.

In some embodiments, the external aviation mission device (e.g., the cloud-based aviation mission device 140 and/or the mobile aviation mission device 120) is configured to receive an inactive aviation implementation state indication. In some embodiments, the external aviation mission device is configured to receive an inactive aviation implementation state indication from the onboard aviation mission device 180. In some embodiments, in response to receiving an inactive aviation implementation state indication, the external aviation mission device is configured to deactivate and/or disarm at least one of the one or more aviation operations programs. For example, in response to receiving an inactive aviation implementation state indication, the external aviation mission device is configured to deactivate and/or disarm the fourth aviation operations program. In this regard, for example, the external aviation mission device (e.g., the cloud-based aviation mission device 140 and/or the mobile aviation mission device 120) and/or the onboard aviation mission device 180 is configured to reduce processing loads and memory consumption by ensuring aviation operations programs that are not needed for the aircraft 110 to complete an aviation mission are not configured in accordance with an active aviation implementation state and/or an armed aviation implementation state.

In some embodiments, the external aviation mission device (e.g., the cloud-based aviation mission device 140 and/or the mobile aviation mission device 120) is configured to receive aviation mission data. In some embodiments, the external aviation mission device is configured to receive aviation mission data in response to a query from the external aviation mission device to the onboard aviation mission device 180. In some embodiments, the external aviation mission device is configured to receive aviation mission data in real-time. In this regard, for example, the external aviation mission device may be configured to receive aviation mission data as the onboard aviation mission device 180 is identifying the aviation mission data. In some embodiments, the external aviation mission device is configured to receive aviation mission data in response to the onboard aviation mission device 180 configuring at least one of the one or more aviation operations programs.

In some embodiments, the external aviation mission device (e.g., the cloud-based aviation mission device 140 and/or the mobile aviation mission device 120) is configured to identify an aviation mission activation event. In some embodiments, an aviation mission activation event is an event that causes an aviation operations program configured in accordance with an armed aviation implementation state (e.g., the first aviation operations program) to be needed for the aircraft 110 to perform an aviation mission. For example, when an aviation operations program configured in accordance with an armed aviation implementation state corresponds to a landing operations program for the aircraft 110, an aviation mission activation event may be an event that includes the aircraft 110 being assigned a runway for landing at a destination airport. As another example, when an aviation operations program configured in accordance with an armed aviation implementation state corresponds to a takeoff operations program for the aircraft 110, an aviation mission activation event may be an event that includes the aircraft 110 being assigned a runway for takeoff at an originating airport. Said differently, for example, an aviation mission activation event may be an event that causes an aviation operations program configured in accordance with an armed aviation implementation state (e.g., the first aviation operations program) to be reconfigured in accordance with an active aviation implementation state.

In some embodiments, the external aviation mission device (e.g., the cloud-based aviation mission device 140 and/or the mobile aviation mission device 120) is configured to generate first program implementation data. In some embodiments, program implementation data includes one or more items of data representative and/or indicative of an output of one of the one or more aviation operations programs. In this regard, in some embodiments, first program implementation data includes one or more items of data representative and/or indicative of an output of the first aviation operations program. In this regard, in some embodiments, when the first aviation operations program is an optimal altitude program, first program implementation data may include one or more items of data representative and/or indicative of an optimal altitude at various points in an aviation mission of the aircraft 110. In some embodiments, when the first aviation operations program is a landing operations program, first program implementation data may include one or more items of data representative and/or indicative of one or more operations that should be performed to perform a landing during an aviation mission. For example, first program implementation data may include one or more items of data representative and/or indicative of one or more operations that should be performed by the external aviation mission device (e.g., the cloud-based aviation mission device 140 and/or the mobile aviation mission device 120), the onboard aviation mission device 180, the one or more aircraft components 190, and/or the aircraft 110 to perform a landing during an aviation mission.

In some embodiments, when the first aviation operations program is a takeoff operations program, first program implementation data may include one or more items of data representative and/or indicative of one or more operations that should be performed to perform a takeoff during an aviation mission. For example, first program implementation data may include one or more items of data representative and/or indicative of one or more operations that should be performed by the external aviation mission device (e.g., the cloud-based aviation mission device 140 and/or the mobile aviation mission device 120), the onboard aviation mission device 180, the one or more aircraft components 190, and/or the aircraft 110 to perform a takeoff during an aviation mission. In some embodiments, when the first aviation operations program is a weather impact operations program, first program implementation data may include one or more items of data representative and/or indicative of weather that may impact an aviation mission. In some embodiments, when the first aviation operations program is a fuel operations program, first program implementation data may include one or more items of data representative and/or indicative of one or more fuel considerations that may impact an aviation mission (e.g., fuel type, fuel expenditure, etc.).

In some embodiments, the external aviation mission device (e.g., the cloud-based aviation mission device 140 and/or the mobile aviation mission device 120) is configured to generate first program implementation data by applying aviation mission data to the first aviation operations program. In this regard, in some embodiments, applying aviation mission data to the first aviation operations program causes the first aviation operations program to be executed to generate first program implementation data. In some embodiments, the external aviation mission device is configured to generate first program implementation data in response to identifying an aviation mission activation event.

In some embodiments, the external aviation mission device (e.g., the cloud-based aviation mission device 140 and/or the mobile aviation mission device 120) is configured to provide first program implementation data. In some embodiments, the external aviation mission device is configured to provide first program implementation data to the onboard aviation mission device 180. In some embodiments, the external aviation mission device provides first program implementation data to the onboard aviation mission device 180 in response to generating the first program implementation data.

In some embodiments, the external aviation mission device (e.g., the cloud-based aviation mission device 140 and/or the mobile aviation mission device 120) is configured to generate second program implementation data. In some embodiments, second program implementation data includes one or more items of data representative and/or indicative of an output of the second aviation operations program. In this regard, in some embodiments, when the second aviation operations program is an optimal altitude program, second program implementation data may include one or more items of data representative and/or indicative of an optimal altitude at various points in an aviation mission of the aircraft 110. In some embodiments, when the second aviation operations program is a landing operations program, second program implementation data may include one or more items of data representative and/or indicative of one or more operations that should be performed to perform a landing during an aviation mission. For example, second program implementation data may include one or more items of data representative and/or indicative of one or more operations that should be performed by the external aviation mission device (e.g., the cloud-based aviation mission device 140 and/or the mobile aviation mission device 120), the onboard aviation mission device 180, the one or more aircraft components 190, and/or the aircraft 110 to perform a landing during an aviation mission.

In some embodiments, when the second aviation operations program is a takeoff operations program, second program implementation data may include one or more items of data representative and/or indicative of one or more operations that should be performed to perform a takeoff during an aviation mission. For example, second program implementation data may include one or more items of data representative and/or indicative of one or more operations that should be performed by the external aviation mission device (e.g., the cloud-based aviation mission device 140 and/or the mobile aviation mission device 120), the onboard aviation mission device 180, the one or more aircraft components 190, and/or the aircraft 110 to perform a takeoff during an aviation mission. In some embodiments, when the second aviation operations program is a weather impact operations program, second program implementation data may include one or more items of data representative and/or indicative of weather that may impact an aviation mission. In some embodiments, when the second aviation operations program is a fuel operations program, second program implementation data may include one or more items of data representative and/or indicative of one or more fuel considerations that may impact an aviation mission (e.g., fuel type, fuel expenditure, etc.).

In some embodiments, the external aviation mission device (e.g., the cloud-based aviation mission device 140 and/or the mobile aviation mission device 120) is configured to generate second program implementation data by applying aviation mission data to the second aviation operations program. In this regard, in some embodiments, applying aviation mission data to the second aviation operations program causes the second aviation operations program to be executed to generate second program implementation data. In some embodiments, the external aviation mission device is configured to generate second program implementation data in response to receiving aviation mission data.

In some embodiments, the external aviation mission device (e.g., the cloud-based aviation mission device 140 and/or the mobile aviation mission device 120) is configured to provide second program implementation data. In some embodiments, the external aviation mission device is configured to provide second program implementation data to the onboard aviation mission device 180. In some embodiments, the external aviation mission device provides second program implementation data to the onboard aviation mission device 180 in response to generating the second program implementation data.

In some embodiments, the onboard aviation mission device 180 is configured to receive first program implementation data. In some embodiments, the onboard aviation mission device 180 is configured to receive first program implementation data from the external aviation mission device (e.g., the cloud-based aviation mission device 140 and/or the mobile aviation mission device 120). In some embodiments, the onboard aviation mission device 180 is configured to receive first program implementation data from the external aviation mission device in response to an aviation mission activation event. In this regard, for example, an aviation mission activation event may cause the external aviation mission device to generate and/or provide first program implementation data.

In some embodiments, the onboard aviation mission device 180 is configured to initiate performance of one or more aviation mission actions. In some embodiments, the onboard aviation mission device 180 is configured to initiate performance of one or more aviation mission actions based on first program implementation data. In this regard, in some embodiments, the onboard aviation mission device 180 is configured to initiate performance of one or more aviation mission actions that includes modifying an aviation mission based on first program implementation data. For example, the onboard aviation mission device 180 is configured to initiate performance of one or more aviation mission actions that includes modifying an aviation mission in accordance with an optimal altitude at various points in the aviation mission of the aircraft 110 as indicated by first program implementation data. As another example, the onboard aviation mission device 180 is configured to initiate performance of one or more aviation mission actions that includes modifying an aviation mission in accordance with operations that should be performed to perform a landing as indicated by first program implementation data (e.g., starting a landing operation at an earlier point in an aviation mission than originally planned).

As another example, the onboard aviation mission device 180 is configured to initiate performance of one or more aviation mission actions that includes modifying an aviation mission in accordance with operations that should be performed to perform a takeoff as indicated by first program implementation data (e.g., perform a takeoff at a different runway than originally planned). As another example, the onboard aviation mission device 180 is configured to initiate performance of one or more aviation mission actions that includes modifying an aviation mission in accordance with weather as indicated by first program implementation data (e.g., modifying an aviation mission to avoid weather in flight). As another example, the onboard aviation mission device 180 is configured to initiate performance of one or more aviation mission actions that includes modifying an aviation mission in accordance with fuel considerations as indicated by first program implementation data (e.g., moving to a higher altitude to expend less fuel in flight).

In some embodiments, the onboard aviation mission device 180 is configured to initiate performance of one or more aviation mission actions that includes causing actuation of one or more of the one or more aircraft components 190 of the aircraft 110. For example, the onboard aviation mission device 180 is configured to initiate performance of one or more aviation mission actions that includes causing actuation of one or more of the one or more aircraft components 190 in accordance with an optimal altitude at various points in the aviation mission of the aircraft 110 as indicated by first program implementation data. As another example, the onboard aviation mission device 180 is configured to initiate performance of one or more aviation mission actions that includes causing actuation of one or more of the one or more aircraft components 190 in accordance with operations that should be performed to perform a landing as indicated by first program implementation data (e.g., cause actuation of the one or more of the one or more aircraft components 190 to start a landing operation at an earlier point in an aviation mission than originally planned).

As another example, the onboard aviation mission device 180 is configured to initiate performance of one or more aviation mission actions that includes causing actuation of one or more of the one or more aircraft components 190 in accordance with operations that should be performed to perform a takeoff as indicated by first program implementation data (e.g., cause actuation of the one or more of the one or more aircraft components 190 to perform a takeoff at a different runway than originally planned). As another example, the onboard aviation mission device 180 is configured to initiate performance of one or more aviation mission actions that includes causing actuation of one or more of the one or more aircraft components 190 in accordance with weather as indicated by first program implementation data (e.g., cause actuation of the one or more of the one or more aircraft components 190 to avoid weather in flight). As another example, the onboard aviation mission device 180 is configured to initiate performance of one or more aviation mission actions that includes causing actuation of one or more of the one or more aircraft components 190 in accordance with fuel considerations as indicated by first program implementation data (e.g., cause actuation of the one or more of the one or more aircraft components 190 to move to a higher altitude to expend less fuel in flight).

In some embodiments, the onboard aviation mission device 180 is configured to receive second program implementation data. In some embodiments, the onboard aviation mission device 180 is configured to receive second program implementation data from the external aviation mission device (e.g., the cloud-based aviation mission device 140 and/or the mobile aviation mission device 120).

In some embodiments, the onboard aviation mission device 180 is configured to initiate performance of one or more aviation mission actions based on second program implementation data. In this regard, in some embodiments, the onboard aviation mission device 180 is configured to initiate performance of one or more aviation mission actions that includes modifying an aviation mission based on second program implementation data. For example, the onboard aviation mission device 180 is configured to initiate performance of one or more aviation mission actions that includes modifying an aviation mission in accordance with an optimal altitude at various points in the aviation mission of the aircraft 110 as indicated by second program implementation data. As another example, the onboard aviation mission device 180 is configured to initiate performance of one or more aviation mission actions that includes modifying an aviation mission in accordance with operations that should be performed to perform a landing as indicated by second program implementation data (e.g., starting a landing operation at an earlier point in an aviation mission than originally planned).

As another example, the onboard aviation mission device 180 is configured to initiate performance of one or more aviation mission actions that includes modifying an aviation mission in accordance with operations that should be performed to perform a takeoff as indicated by second program implementation data (e.g., perform a takeoff at a different runway than originally planned). As another example, the onboard aviation mission device 180 is configured to initiate performance of one or more aviation mission actions that includes modifying an aviation mission in accordance with weather as indicated by second program implementation data (e.g., modifying an aviation mission to avoid weather in flight). As another example, the onboard aviation mission device 180 is configured to initiate performance of one or more aviation mission actions that includes modifying an aviation mission in accordance with fuel considerations as indicated by second program implementation data (e.g., moving to a higher altitude to expend less fuel in flight).

In some embodiments, the onboard aviation mission device 180 is configured to initiate performance of one or more aviation mission actions that includes causing actuation of one or more of the one or more aircraft components 190 of the aircraft 110. For example, the onboard aviation mission device 180 is configured to initiate performance of one or more aviation mission actions that includes causing actuation of one or more of the one or more aircraft components 190 in accordance with an optimal altitude at various points in the aviation mission of the aircraft 110 as indicated by second program implementation data. As another example, the onboard aviation mission device 180 is configured to initiate performance of one or more aviation mission actions that includes causing actuation of one or more of the one or more aircraft components 190 in accordance with operations that should be performed to perform a landing as indicated by second program implementation data (e.g., cause actuation of the one or more of the one or more aircraft components 190 to start a landing operation at an earlier point in an aviation mission than originally planned).

As another example, the onboard aviation mission device 180 is configured to initiate performance of one or more aviation mission actions that includes causing actuation of one or more of the one or more aircraft components 190 in accordance with operations that should be performed to perform a takeoff as indicated by second program implementation data (e.g., cause actuation of the one or more of the one or more aircraft components 190 to perform a takeoff at a different runway than originally planned). As another example, the onboard aviation mission device 180 is configured to initiate performance of one or more aviation mission actions that includes causing actuation of one or more of the one or more aircraft components 190 in accordance with weather as indicated by second program implementation data (e.g., cause actuation of the one or more of the one or more aircraft components 190 to avoid weather in flight). As another example, the onboard aviation mission device 180 is configured to initiate performance of one or more aviation mission actions that includes causing actuation of one or more of the one or more aircraft components 190 in accordance with fuel considerations as indicated by second program implementation data (e.g., cause actuation of the one or more of the one or more aircraft components 190 to move to a higher altitude to expend less fuel in flight).

In some embodiments, the onboard aviation mission device 180 is configured to configure at least one of the one or more aviation operations programs in accordance with at least one of a plurality of aviation activation states. In some embodiments, an aviation activation state is a data object that controls initiating performance of one or more aviation mission actions based on first program implementation data and/or second program implementation data. In some embodiments, the plurality of aviation activation states includes a primary aviation activation state. In some embodiments, a primary aviation activation state is a data object that causes one or more aviation mission actions to be initiated in response to the onboard aviation mission device 180 receiving first program implementation data and/or second first program implementation data. In this regard, for example, performance of one or more aviation mission actions that are based on first program implementation data and/or second first program implementation data that was generated by an aviation operations program configured in accordance with a primary aviation activation state may be automatically initiated when the first program implementation data and/or second first program implementation data is received by the onboard aviation mission device 180. In some embodiments, a primary aviation activation state is associated with one or more aviation mission actions that are initiated when the aircraft 110 is in a preflight procedure portion, leaving a gate portion, taxiing portion, and/or parking at a gate performing post flight procedures portion of an aviation mission.

In some embodiments, the plurality of aviation activation states includes a secondary aviation activation state. In some embodiments, a secondary aviation activation state is a data object that causes one or more aviation mission actions to be initiated in response to the onboard aviation mission device 180 receiving an input from an operator of the aircraft 110 (e.g., a pilot). In this regard, for example, performance of one or more aviation mission actions that are based on first program implementation data and/or second first program implementation data that was generated by an aviation operations program configured in accordance with a secondary aviation activation state may be initiated upon approval of an operator of the aircraft 110. In some embodiments, a secondary aviation activation state is associated with one or more aviation mission actions that are initiated when the aircraft 110 is in a taking off portion, in flight portion, and/or landing portion of an aviation mission.

In some embodiments, the onboard aviation mission device 180 is configured to generate an aviation operations program interface component 302. In some embodiments, the aviation operations program interface component 302 is generated based on aviation operations program data. In this regard, in some embodiments, the aviation operations program interface component 302 is configured to display one or more aviation operations programs. For example, the aviation operations program interface component 302 may be configured to display an optimal altitude program. As another example, the aviation operations program interface component 302 may be configured to display a landing operations program. As another example, the aviation operations program interface component 302 may be configured to display takeoff operations program. As another example, the aviation operations program interface component 302 may be configured to display a weather impact program. As another example, the aviation operations program interface component 302 may be configured to display fuel operations program.

In some embodiments, the onboard aviation mission device 180 is configured to generate an aviation operations program implementation interface component 400. In some embodiments, the aviation operations program implementation interface component 400 is configured to enable configuration of one or more aviation operations programs in accordance with one of a plurality of aviation implementation states. In this regard, for example, the aviation operations program implementation interface component 400 is configured to enable configuration of an optimal altitude program in accordance with an active aviation implementation state. As another example, the aviation operations program implementation interface component 400 is configured to enable configuration of takeoff operations program in accordance with an armed aviation implementation state. As another example, the aviation operations program implementation interface component 400 is configured to enable configuration of a landing operations program in accordance with an inactive aviation implementation state. As another example, the aviation operations program implementation interface component 400 is configured to enable configuration of a weather impact program in accordance with a cancelled aviation implementation state.

In some embodiments, the onboard aviation mission device 180 is configured to generate an aviation operations program activation interface component 500. In some embodiments, the aviation operations program activation interface component 500 is configured to enable configuration of one or more aviation operations programs in accordance with one of a plurality of aviation activation states. As another example, the aviation operations program activation interface component 500 is configured to enable configuration of an aviation operations program in accordance with a primary aviation activation state. As another example, the aviation operations program activation interface component 500 is configured to enable configuration of an aviation operations program in accordance with a secondary aviation activation state.

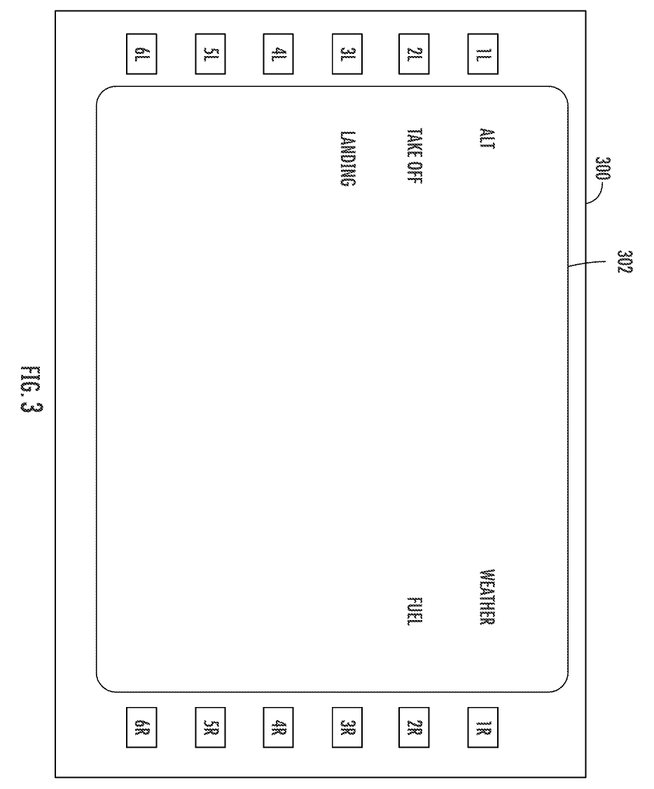

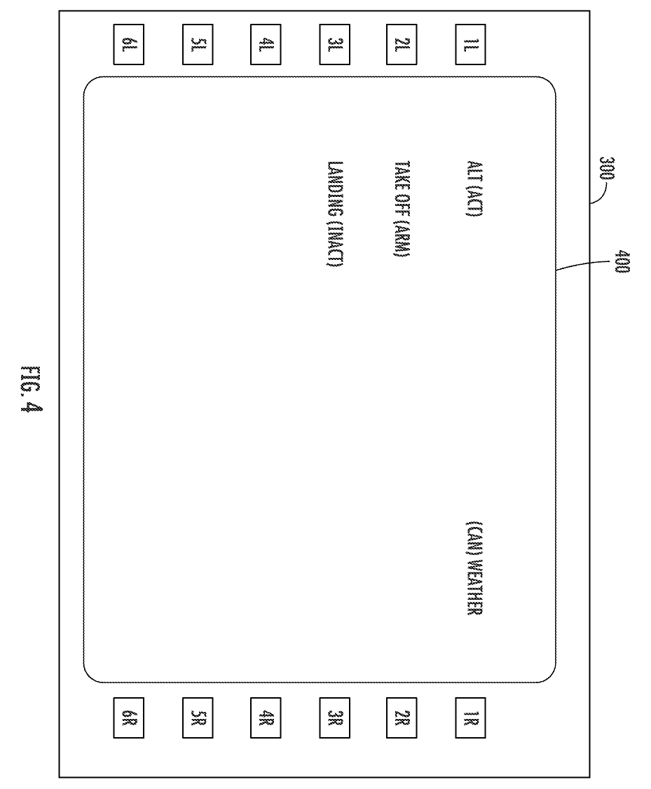

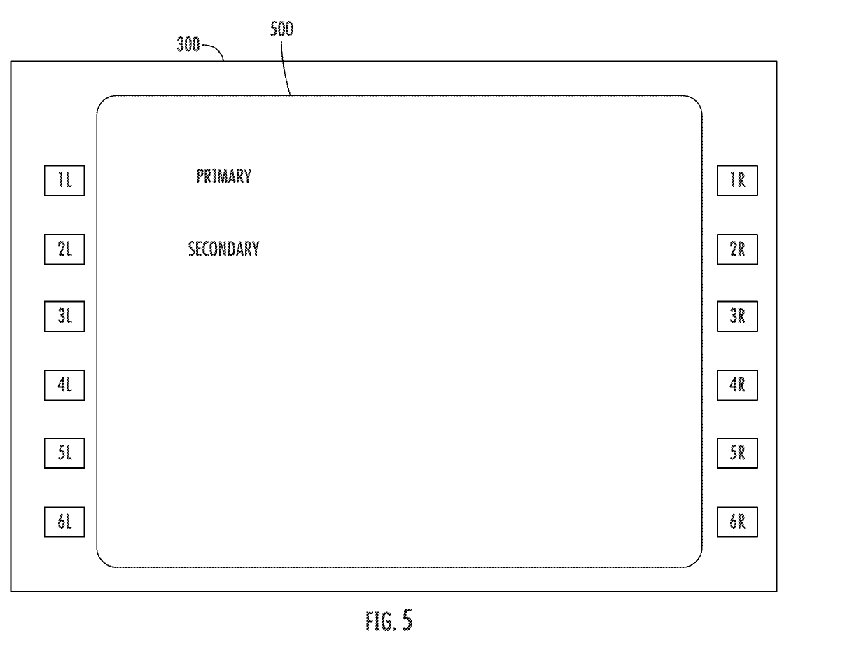

In some embodiments, the onboard aviation mission device 180 is configured to cause the aviation operations program interface component 302 to be rendered to an aircraft operations interface 300, such as illustrated in FIG. 3. In some embodiments, the onboard aviation mission device 180 is configured to cause the aviation operations program implementation interface component 400 to be rendered to an aircraft operations interface 300, such as illustrated in FIG. 4. In some embodiments, the onboard aviation mission device 180 is configured to cause the aviation operations program activation interface component 500 to be rendered to an aircraft operations interface 300, such as illustrated in FIG. 5. In some embodiments, the aircraft operations interface 300 provided on the onboard aviation mission device 180, the mobile aviation mission device 120, the cloud-based aviation mission device 140, and/or the one or more aircraft components 190. For example, the aircraft operations interface 300 may be provided on a multi-function control and display unit of the aircraft 110.

### Example Methods

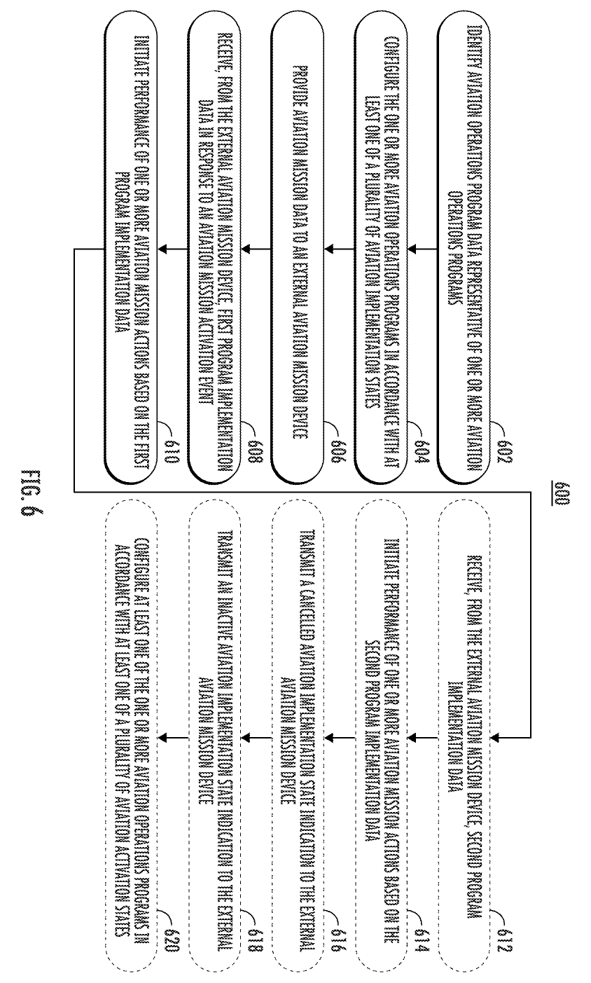

Referring now to FIG. 6, a flowchart providing an example method 600 is illustrated. In this regard, FIG. 6 illustrates operations that may be performed by the mobile aviation mission device 120, the cloud-based aviation mission device 140, the onboard aviation mission device 180, the one or more aircraft components 190, and/or the one or more databases 170. In some embodiments, the method 600 includes operations for initiating performance of one or more aviation mission actions. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 includes identifying aviation operations program data representative of one or more aviation operations programs. As described above, in some embodiments, aviation operations program data includes one or more items of data representative and/or indicative of one or more aviation operations programs. In some embodiments, an aviation operations program is an aviation related computing program that when executed generates program implementation data. For example, the one or more aviation operations programs includes one or more optimal altitude programs configured to generate program implementation data. As another example, the one or more aviation operations programs includes one or more landing operations programs configured to generate program implementation data. As another example, the one or more aviation operations programs includes one or more takeoff operations programs configured to generate program implementation data. As another example, the one or more aviation operations programs includes one or more weather impact programs configured to generate program implementation data. As another example, the one or more aviation operations programs includes one or more fuel operations programs configured to generate program implementation data.

In some embodiments, identifying aviation operations program data includes the onboard aviation mission device being configured to receive aviation operations program data. In some embodiments, the onboard aviation mission device is configured to receive aviation operations program data from the external aviation mission device (e.g., the cloud-based aviation mission device and/or the mobile aviation mission device). In some embodiments, the onboard aviation mission device is configured to receive aviation operations program data from the external aviation mission device (e.g., the cloud-based aviation mission device and/or the mobile aviation mission device) in response to a query from the onboard aviation mission device.

As shown in block 604, the method 600 includes configuring the one or more aviation operations programs in accordance with at least one of a plurality of aviation implementation states. As described above, in some embodiments, the plurality of aviation implementation states includes an armed aviation implementation state. In this regard, in some embodiments, the onboard aviation mission device is configured to configure a first aviation operations program of the plurality of aviation operations programs in accordance with an armed aviation implementation state.

In some embodiments, an aviation operations program configured in accordance with an armed aviation implementation state corresponds to an aviation operations program (e.g., the first aviation operations program) that is configured to be executed upon occurrence of an aviation mission activation event. Said differently, for example, an aviation operations program configured in accordance with an armed aviation implementation state corresponds to an aviation operations program that is not currently needed for the aircraft to perform an aviation mission but will be needed at a future point in the aviation mission. For example, an aviation operations program configured in accordance with an armed aviation implementation state may correspond to landing operations program for the aircraft when the aircraft is in flight but has not yet been assigned a runway for landing at a destination airport.

In some embodiments, the plurality of aviation implementation states includes an active aviation implementation state. In this regard, in some embodiments, the onboard aviation mission device is configured to configure a second aviation operations program of the plurality of aviation operations programs in accordance with an active aviation implementation state. In some embodiments, an aviation operations program configured in accordance with an active aviation implementation state corresponds to an aviation operations program (e.g., the second aviation operations program) that is configured to be executed upon being configured. Said differently, for example, an aviation operations program configured in accordance with an active aviation implementation state corresponds to an aviation operations program that is currently needed for the aircraft to perform an aviation mission such that the aviation operations program is executed upon being configured in accordance with an active aviation implementation state. For example, an aviation operations program configured in accordance with an active aviation implementation state may correspond to optimal altitude program for the aircraft when the aircraft is in flight.

In some embodiments, the plurality of aviation implementation states includes a cancelled aviation implementation state. In this regard, in some embodiments, the onboard aviation mission device is configured to configure a third aviation operations program of the plurality of aviation operations programs in accordance with a cancelled aviation implementation state. In some embodiments, an aviation operations program configured in accordance with a cancelled aviation implementation state corresponds to an aviation operations program (e.g., the third aviation operations program) that is not needed to perform an aviation mission. For example, an aviation operations program configured in accordance with a cancelled aviation implementation state may correspond to optimal altitude program for the aircraft when the altitude of the aircraft is being directed by an air traffic controller (ATC).

In some embodiments, the plurality of aviation implementation states includes an inactive aviation implementation state. In this regard, in some embodiments, the onboard aviation mission device is configured to configure a fourth aviation operations program of the plurality of aviation operations programs in accordance with an inactive aviation implementation state. In some embodiments, an aviation operations program (e.g., the fourth aviation operations program) configured in accordance with an inactive aviation implementation state corresponds to an aviation operations program that that was previously executed during an aviation mission. Said differently, for example, an aviation operations program configured in accordance with an inactive aviation implementation state corresponds to an aviation operations program that was previously executed during an aviation mission and is no longer needed to complete the aviation mission. For example, an aviation operations program configured in accordance with an inactive aviation implementation state may correspond to takeoff operations program for the aircraft when the aircraft has already taken off and is in flight.

As shown in block 606, the method 600 includes providing aviation mission data to an external aviation mission device. As described above, in some embodiments, aviation mission data includes one or more items of data representative and/or indicative of operations of the aircraft. For example, aviation mission data may include one or more items of data representative and/or indicative of engine performance of the aircraft. As another example, aviation mission data may include one or more items of data representative and/or indicative of fuel consumption of the aircraft. As another example, aviation mission data may include one or more items of data representative and/or indicative of weather in proximity to the aircraft and/or weather along a flight path used by the aircraft to complete an aviation mission (e.g., weather information provided by an originating airport). As another example, aviation mission data may include one or more items of data representative and/or indicative of a flight path of the aircraft.

As another example, aviation mission data may include one or more items of data representative and/or indicative of an altitude associated with the aircraft. As another example, aviation mission data may include one or more items of data representative and/or indicative of a heading associated with the aircraft. As another example, aviation mission data may include one or more items of data representative and/or indicative of a speed associated with the aircraft. As another example, aviation mission data may include one or more items of data representative and/or indicative of a position of the aircraft. As another example, aviation mission data may include one or more items of data representative and/or indicative of aircraft traffic in proximity to the aircraft and/or aircraft traffic along a flight path used by the aircraft to complete an aviation mission. As another example, aviation mission data may include one or more items of data representative and/or indicative of a takeoff runway associated with the aircraft (e.g., at an originating airport).

As another example, aviation mission data may include one or more items of data representative and/or indicative of a landing runway associated with the aircraft (e.g., at a destination airport). As another example, aviation mission data may include one or more items of data representative and/or indicative of taxiways associated with the aircraft (e.g., at an originating airport and/or at a destination airport). As another example, aviation mission data may include one or more items of data representative and/or indicative of a flight time associated with the aircraft. As another example, aviation mission data may include one or more items of data representative and/or indicative of a time of arrival associated with the aircraft. As another example, aviation mission data may include one or more items of data representative and/or indicative of a flight plan associated with the aircraft.

In some embodiments, identifying aviation mission data includes the onboard aviation mission device being configured to receive aviation mission data. For example, the onboard aviation mission device may be configured to receive aviation mission data from the one or more aircraft components. As another example, the onboard aviation mission device may be configured to receive aviation mission data from an operator (e.g., a pilot) of the aircraft. In some embodiments, identifying aviation mission data includes the onboard aviation mission device being configured to generate aviation mission data. For example, the onboard aviation mission device may be configured to generate aviation mission data using the one or more aircraft components.

In some embodiments, the onboard aviation mission device is configured to provide aviation mission data. In some embodiments, the onboard aviation mission device is configured to provide aviation mission data to the external aviation mission device (e.g., the cloud-based aviation mission device and/or the mobile aviation mission device). In some embodiments, the onboard aviation mission device is configured to provide aviation mission data for each of the one or more aviation operations programs. In some embodiments, the onboard aviation mission device is configured to provide aviation mission data in real-time. In this regard, for example, the onboard aviation mission device may be configured to provide aviation mission data as the onboard aviation mission device identifies the aviation mission data.

As shown in block 608, the method 600 includes receiving, from the external aviation mission device, first program implementation data in response to an aviation mission activation event. As described above, in some embodiments, the onboard aviation mission device is configured to receive first program implementation data from the external aviation mission device in response to an aviation mission activation event. In this regard, for example, an aviation mission activation event may cause the external aviation mission device to generate and/or provide first program implementation data.

As shown in block 610, the method 600 includes initiating performance of one or more aviation mission actions based on the first program implementation data. As described above, for example, performance of one or more aviation mission actions may include causing actuation of one or more aircraft components associated with the aircraft and/or modifying an aviation mission.

As shown in optional block 612, the method 600 optionally includes receiving, from the external aviation mission device, second program implementation data. As described above, for example, second program implementation data may be received from the external aviation mission device after the external aviation mission device has generated the second program implementation data.

As shown in optional block 614, the method 600 optionally includes initiating performance of one or more aviation mission actions based on the second program implementation data. As described above, for example, performance of one or more aviation mission actions may include causing actuation of one or more aircraft components associated with the aircraft and/or modifying an aviation mission.

As shown in optional block 616, the method 600 optionally includes transmitting a cancelled aviation implementation state indication to the external aviation mission device. As described above, in some embodiments, a cancelled aviation implementation state indication is configured to indicate that the third aviation operations program of the one or more aviation operations programs has been configured in accordance with a cancelled aviation implementation state of the plurality of aviation implementation states. In some embodiments, a cancelled aviation implementation state indication may be transmitted from the onboard aviation mission device to the external aviation mission device (e.g., the cloud-based aviation mission device and/or the mobile aviation mission device). In some embodiments, a cancelled aviation implementation state indication may be transmitted from the onboard aviation mission device in response to the third aviation operations program being configured in accordance with a cancelled aviation implementation state.

As shown in optional block 618, the method 600 optionally includes transmitting an inactive aviation implementation state indication to the external aviation mission device. As described above, in some embodiments, an inactive aviation implementation state indication is configured to indicate that the fourth aviation operations program of the one or more aviation operations programs has been configured in accordance with an inactive aviation implementation state of the plurality of aviation implementation states. In some embodiments, an inactive aviation implementation state indication may be transmitted from the onboard aviation mission device to the external aviation mission device (e.g., the cloud-based aviation mission device and/or the mobile aviation mission device). In some embodiments, an inactive aviation implementation state indication may be transmitted from the onboard aviation mission device in response to the fourth aviation operations program being configured in accordance with an inactive aviation implementation state.

As shown in optional block 620, the method 600 optionally includes configuring at least one of the one or more aviation operations programs in accordance with at least one of a plurality of aviation activation states. As described above, in some embodiments, an aviation activation state is a data object that controls initiating performance of one or more aviation mission actions based on first program implementation data and/or second program implementation data. In some embodiments, the plurality of aviation activation states includes a primary aviation activation state. In some embodiments, a primary aviation activation state is a data object that causes one or more aviation mission actions to be initiated in response to the onboard aviation mission device receiving first program implementation data and/or second first program implementation data. In this regard, for example, performance of one or more aviation mission actions that are based on first program implementation data and/or second first program implementation data that was generated by an aviation operations program configured in accordance with a primary aviation activation state may be automatically initiated when the first program implementation data and/or second first program implementation data is received by the onboard aviation mission device. In some embodiments, a primary aviation activation state is associated with one or more aviation mission actions that are initiated when the aircraft is in a preflight procedure portion, leaving a gate portion, taxiing portion, and/or parking at a gate performing post flight procedures portion of an aviation mission.

In some embodiments, the plurality of aviation activation states includes a secondary aviation activation state. In some embodiments, a secondary aviation activation state is a data object that causes one or more aviation mission actions to be initiated in response to the onboard aviation mission device receiving an input from an operator of the aircraft (e.g., a pilot). In this regard, for example, performance of one or more aviation mission actions that are based on first program implementation data and/or second first program implementation data that was generated by an aviation operations program configured in accordance with a secondary aviation activation state may be initiated upon approval of an operator of the aircraft. In some embodiments, a secondary aviation activation state is associated with one or more aviation mission actions that are initiated when the aircraft is in a taking off portion, in flight portion, and/or landing portion of an aviation mission.

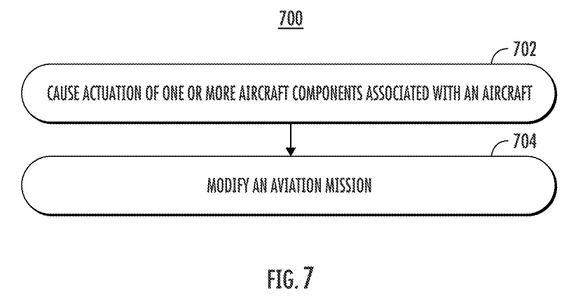

Referring now to FIG. 7, a flowchart providing an example method 700 is illustrated. In this regard, FIG. 7 illustrates operations that may be performed by the mobile aviation mission device 120, the cloud-based aviation mission device 140, the onboard aviation mission device 180, the one or more aircraft components 190, and/or the one or more databases 170. In some embodiments, the method 700 includes operations related to one or more aviation mission actions. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 includes causing actuation of one or more aircraft components associated with an aircraft. As described above, in some embodiments, the onboard aviation mission device is configured to initiate performance of one or more aviation mission actions that includes causing actuation of one or more of the one or more aircraft components in accordance with an optimal altitude at various points in the aviation mission of the aircraft as indicated by first program implementation data and/or second program implementation data. As another example, the onboard aviation mission device is configured to initiate performance of one or more aviation mission actions that includes causing actuation of one or more of the one or more aircraft components in accordance with operations that should be performed to perform a landing as indicated by first program implementation data and/or second program implementation data (e.g., cause actuation of the one or more of the one or more aircraft components to start a landing operation at an earlier point in an aviation mission than originally planned).

As another example, the onboard aviation mission device is configured to initiate performance of one or more aviation mission actions that includes causing actuation of one or more of the one or more aircraft components in accordance with operations that should be performed to perform a takeoff as indicated by first program implementation data and/or second program implementation data (e.g., cause actuation of the one or more of the one or more aircraft components to perform a takeoff at a different runway than originally planned). As another example, the onboard aviation mission device is configured to initiate performance of one or more aviation mission actions that includes causing actuation of one or more of the one or more aircraft components in accordance with weather as indicated by first program implementation data and/or second program implementation data (e.g., cause actuation of the one or more of the one or more aircraft components to avoid weather in flight). As another example, the onboard aviation mission device is configured to initiate performance of one or more aviation mission actions that includes causing actuation of one or more of the one or more aircraft components in accordance with fuel considerations as indicated by first program implementation data and/or second program implementation data (e.g., cause actuation of the one or more of the one or more aircraft components to move to a higher altitude to expend less fuel in flight).

As shown in block 704, the method 700 includes modifying an aviation mission. As described above, in some embodiments, the onboard aviation mission device is configured to initiate performance of one or more aviation mission actions that includes modifying an aviation mission based on first program implementation data and/or second program implementation data. For example, the onboard aviation mission device is configured to initiate performance of one or more aviation mission actions that includes modifying an aviation mission in accordance with an optimal altitude at various points in the aviation mission of the aircraft as indicated by first program implementation data and/or second program implementation data. As another example, the onboard aviation mission device is configured to initiate performance of one or more aviation mission actions that includes modifying an aviation mission in accordance with operations that should be performed to perform a landing as indicated by first program implementation data and/or second program implementation data (e.g., starting a landing operation at an earlier point in an aviation mission than originally planned).

As another example, the onboard aviation mission device is configured to initiate performance of one or more aviation mission actions that includes modifying an aviation mission in accordance with operations that should be performed to perform a takeoff as indicated by first program implementation data and/or second program implementation data (e.g., perform a takeoff at a different runway than originally planned). As another example, the onboard aviation mission device is configured to initiate performance of one or more aviation mission actions that includes modifying an aviation mission in accordance with weather as indicated by first program implementation data and/or second program implementation data (e.g., modifying an aviation mission to avoid weather in flight). As another example, the onboard aviation mission device is configured to initiate performance of one or more aviation mission actions that includes modifying an aviation mission in accordance with fuel considerations as indicated by first program implementation data and/or second program implementation data (e.g., moving to a higher altitude to expend less fuel in flight).

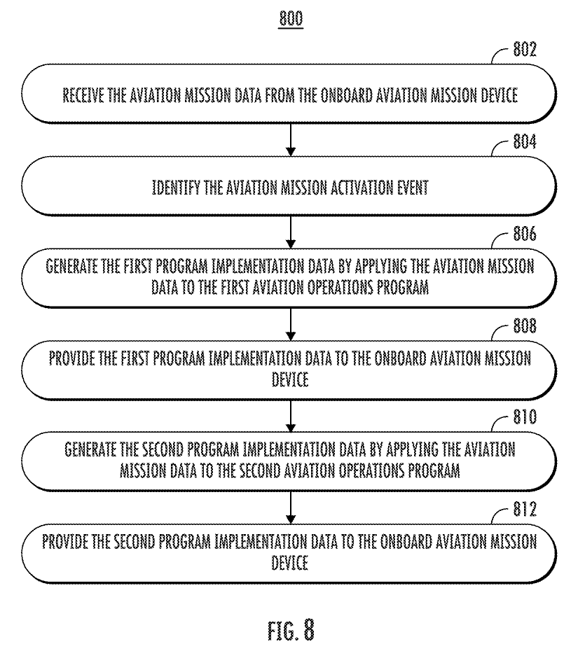

Referring now to FIG. 8, a flowchart providing an example method 800 is illustrated. In this regard, FIG. 8 illustrates operations that may be performed by the mobile aviation mission device 120, the cloud-based aviation mission device 140, the onboard aviation mission device 180, the one or more aircraft components 190, and/or the one or more databases 170. In some embodiments, the method 800 includes operations for providing program implementation data. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 includes receiving the aviation mission data from the onboard aviation mission device. As described above, in some embodiments, the external aviation mission device is configured to receive aviation mission data in response to a query from the external aviation mission device to the onboard aviation mission device. In some embodiments, the external aviation mission device is configured to receive aviation mission data in real-time. In this regard, for example, the external aviation mission device may be configured to receive aviation mission data as the onboard aviation mission device is identifying the aviation mission data. In some embodiments, the external aviation mission device is configured to receive aviation mission data in response to the onboard aviation mission device configuring at least one of the one or more aviation operations programs.

As shown in block 804, the method 800 includes identifying the aviation mission activation event. As described above, in some embodiments, an aviation mission activation event is an event that causes an aviation operations program configured in accordance with an armed aviation implementation state (e.g., the first aviation operations program) to be needed for the aircraft to perform an aviation mission. For example, when an aviation operations program configured in accordance with an armed aviation implementation state corresponds to a landing operations program for the aircraft, an aviation mission activation event may be an event that includes the aircraft being assigned a runway for landing at a destination airport. As another example, when an aviation operations program configured in accordance with an armed aviation implementation state corresponds to a takeoff operations program for the aircraft, an aviation mission activation event may be an event that includes the aircraft being assigned a runway for takeoff at an originating airport. Said differently, for example, an aviation mission activation event may be an event that causes an aviation operations program configured in accordance with an armed aviation implementation state (e.g., the first aviation operations program) to be reconfigured in accordance with an active aviation implementation state.

As shown in block 806, the method 800 includes generating the first program implementation data by applying the aviation mission data to the first aviation operations program. As described above, in some embodiments, program implementation data includes one or more items of data representative and/or indicative of an output of one of the one or more aviation operations programs. In this regard, in some embodiments, first program implementation data includes one or more items of data representative and/or indicative of an output of the first aviation operations program. In this regard, in some embodiments, when the first aviation operations program is an optimal altitude program, first program implementation data may include one or more items of data representative and/or indicative of an optimal altitude at various points in an aviation mission of the aircraft. In some embodiments, when the first aviation operations program is a landing operations program, first program implementation data may include one or more items of data representative and/or indicative of one or more operations that should be performed to perform a landing during an aviation mission. For example, first program implementation data may include one or more items of data representative and/or indicative of one or more operations that should be performed by the external aviation mission device (e.g., the cloud-based aviation mission device and/or the mobile aviation mission device), the onboard aviation mission device, the one or more aircraft components, and/or the aircraft to perform a landing during an aviation mission.

In some embodiments, when the first aviation operations program is a takeoff operations program, first program implementation data may include one or more items of data representative and/or indicative of one or more operations that should be performed to perform a takeoff during an aviation mission. For example, first program implementation data may include one or more items of data representative and/or indicative of one or more operations that should be performed by the external aviation mission device (e.g., the cloud-based aviation mission device and/or the mobile aviation mission device), the onboard aviation mission device, the one or more aircraft components, and/or the aircraft to perform a takeoff during an aviation mission. In some embodiments, when the first aviation operations program is a weather impact operations program, first program implementation data may include one or more items of data representative and/or indicative of weather that may impact an aviation mission. In some embodiments, when the first aviation operations program is a fuel operations program, first program implementation data may include one or more items of data representative and/or indicative of one or more fuel considerations that may impact an aviation mission (e.g., fuel type, fuel expenditure, etc.).

In some embodiments, the external aviation mission device (e.g., the cloud-based aviation mission device and/or the mobile aviation mission device) is configured to generate first program implementation data by applying aviation mission data to the first aviation operations program. In this regard, in some embodiments, applying aviation mission data to the first aviation operations program causes the first aviation operations program to be executed to generate first program implementation data. In some embodiments, the external aviation mission device is configured to generate first program implementation data in response to identifying an aviation mission activation event.

As shown in block 808, the method 800 includes providing the first program implementation data to the onboard aviation mission device. As described above, in some embodiments, the external aviation mission device provides first program implementation data to the onboard aviation mission device in response to generating the first program implementation data.

As shown in block 810, the method 800 includes generating the second program implementation data by applying the aviation mission data to the second aviation operations program. As described above, in some embodiments, second program implementation data includes one or more items of data representative and/or indicative of an output of the second aviation operations program. In this regard, in some embodiments, when the second aviation operations program is an optimal altitude program, second program implementation data may include one or more items of data representative and/or indicative of an optimal altitude at various points in an aviation mission of the aircraft. In some embodiments, when the second aviation operations program is a landing operations program, second program implementation data may include one or more items of data representative and/or indicative of one or more operations that should be performed to perform a landing during an aviation mission. For example, second program implementation data may include one or more items of data representative and/or indicative of one or more operations that should be performed by the external aviation mission device (e.g., the cloud-based aviation mission device and/or the mobile aviation mission device), the onboard aviation mission device, the one or more aircraft components, and/or the aircraft to perform a landing during an aviation mission.

In some embodiments, when the second aviation operations program is a takeoff operations program, second program implementation data may include one or more items of data representative and/or indicative of one or more operations that should be performed to perform a takeoff during an aviation mission. For example, second program implementation data may include one or more items of data representative and/or indicative of one or more operations that should be performed by the external aviation mission device (e.g., the cloud-based aviation mission device and/or the mobile aviation mission device), the onboard aviation mission device, the one or more aircraft components, and/or the aircraft to perform a takeoff during an aviation mission. In some embodiments, when the second aviation operations program is a weather impact operations program, second program implementation data may include one or more items of data representative and/or indicative of weather that may impact an aviation mission. In some embodiments, when the second aviation operations program is a fuel operations program, second program implementation data may include one or more items of data representative and/or indicative of one or more fuel considerations that may impact an aviation mission (e.g., fuel type, fuel expenditure, etc.).

In some embodiments, the external aviation mission device (e.g., the cloud-based aviation mission device and/or the mobile aviation mission device) is configured to generate second program implementation data by applying aviation mission data to the second aviation operations program. In this regard, in some embodiments, applying aviation mission data to the second aviation operations program causes the second aviation operations program to be executed to generate second program implementation data. In some embodiments, the external aviation mission device is configured to generate second program implementation data in response to receiving aviation mission data.

As shown in block 812, the method 800 includes providing the second program implementation data to the onboard aviation mission device. As described above, in some embodiments, the external aviation mission device provides second program implementation data to the onboard aviation mission device in response to generating the second program implementation data.

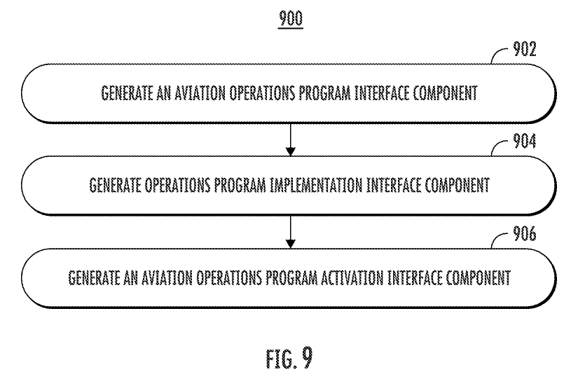

Referring now to FIG. 9, a flowchart providing an example method 900 is illustrated. In this regard, FIG. 9 illustrates operations that may be performed by the mobile aviation mission device 120, the cloud-based aviation mission device 140, the onboard aviation mission device 180, the one or more aircraft components 190, and/or the one or more databases 170. In some embodiments, the method 900 includes operations for generating one or more interface components. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900.

As shown in block 902, the method 900 includes generating an aviation operations program interface component. As described above, in some embodiments, the aviation operations program interface component is generated based on aviation operations program data. In this regard, in some embodiments, the aviation operations program interface component is configured to display one or more aviation operations programs. For example, the aviation operations program interface component may be configured to display an optimal altitude program. As another example, the aviation operations program interface component may be configured to display a landing operations program. As another example, the aviation operations program interface component may be configured to display takeoff operations program. As another example, the aviation operations program interface component may be configured to display a weather impact program. As another example, the aviation operations program interface component may be configured to display fuel operations program.

As shown in block 904, the method 900 includes generating an aviation operations program implementation interface component. As described above, in some embodiments, the aviation operations program implementation interface component is configured to enable configuration of one or more aviation operations programs in accordance with one of a plurality of aviation implementation states. In this regard, for example, the aviation operations program implementation interface component is configured to enable configuration of an optimal altitude program in accordance with an active aviation implementation state. As another example, the aviation operations program implementation interface component is configured to enable configuration of takeoff operations program in accordance with an armed aviation implementation state. As another example, the aviation operations program implementation interface component is configured to enable configuration of a landing operations program in accordance with an inactive aviation implementation state. As another example, the aviation operations program implementation interface component is configured to enable configuration of a weather impact program in accordance with a cancelled aviation implementation state.

As shown in block 906, the method 900 includes generating an aviation operations program activation interface component. As described above, in some embodiments, the aviation operations program activation interface component is configured to enable configuration of one or more aviation operations programs in accordance with one of a plurality of aviation activation states. As another example, the aviation operations program activation interface component is configured to enable configuration of an aviation operations program in accordance with a primary aviation activation state. As another example, the aviation operations program activation interface component is configured to enable configuration of an aviation operations program in accordance with a secondary aviation activation state.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A system comprising:
an onboard aviation mission device comprising memory and one or more processors communicatively coupled to the memory, the one or more processors configured to:
identify aviation operations program data representative of one or more aviation operations programs;
configure the one or more aviation operations programs in accordance with at least one of a plurality of aviation implementation states, wherein a first aviation operations program of the one or more aviation operations programs is configured in accordance with an armed aviation implementation state of the plurality of aviation implementation states;
provide aviation mission data to an external aviation mission device;
receive, from the external aviation mission device, first program implementation data in response to an aviation mission activation event; and
initiate performance of one or more aviation mission actions based on the first program implementation data.

2. The system of claim 1, wherein a second aviation operations program of the one or more aviation operations programs is configured in accordance with an active aviation implementation state of the plurality of aviation implementation states.

3. The system of claim 2, wherein the one or more processors are further configured to:
receive, from the external aviation mission device, second program implementation data; and
initiate performance of one or more aviation mission actions based on the second program implementation data.

4. The system of claim 1, wherein a third aviation operations program of the one or more aviation operations programs is configured in accordance with a cancelled aviation implementation state of the plurality of aviation implementation states.

5. The system of claim 4, wherein the one or more processors are further configured to:
transmit a cancelled aviation implementation state indication to the external aviation mission device.

6. The system of claim 1, wherein a fourth aviation operations program of the one or more aviation operations programs is configured in accordance with an inactive aviation implementation state of the plurality of aviation implementation states.

7. The system of claim 6, wherein the one or more processors are further configured to:
transmit an inactive aviation implementation state indication to the external aviation mission device.

8. The system of claim 1, wherein initiating performance of one or more aviation mission actions based on the first program implementation data comprises the one or more processors being further configured to:
cause actuation of one or more aircraft components associated with an aircraft.

9. The system of claim 1, wherein initiating performance of one or more aviation mission actions based on the first program implementation data comprises the one or more processors being further configured to:
modify an aviation mission.

10. The system of claim 1, wherein the one or more processors are further configured to:
configure at least one of the one or more aviation operations programs in accordance with at least one of a plurality of aviation activation states.

11. The system of claim 10, wherein the plurality of aviation activation states comprises a primary aviation activation state.

12. The system of claim 10, wherein the plurality of aviation activation states comprises a secondary aviation activation state.

13. The system of claim 1, further comprising:
the external aviation mission device comprising second memory and one or more second processors communicatively coupled to the second memory, the one or more second processors configured to:
receive the aviation mission data from the onboard aviation mission device; identify the aviation mission activation event; generate the first program implementation data by applying the aviation mission data to the first aviation operations program; and provide the first program implementation data to the onboard aviation mission device.

14. The system of claim 3, further comprising:
the external aviation mission device comprising second memory and one or more second processors communicatively coupled to the second memory, the one or more second processors configured to:
receive the aviation mission data from the onboard aviation mission device; generate the second program implementation data by applying the aviation mission data to the second aviation operations program; and provide the second program implementation data to the onboard aviation mission device.

15. The system of claim 1, wherein the one or more processors are further configured to:
generate one or more of an aviation operations program interface component, an aviation operations program implementation interface component, or an aviation operations program activation interface component.

16. A method comprising:
identifying aviation operations program data representative of one or more aviation operations programs; configuring the one or more aviation operations programs in accordance with at least one of a plurality of aviation implementation states, wherein a first aviation operations program of the one or more aviation operations programs is configured in accordance with an armed aviation implementation state of the plurality of aviation implementation states; providing aviation mission data to an external aviation mission device; receiving, from the external aviation mission device, first program implementation data in response to an aviation mission activation event; and initiating performance of one or more aviation mission actions based on the first program implementation data.

17. The method of claim 16, wherein a second aviation operations program of the one or more aviation operations programs is configured in accordance with an active aviation implementation state of the plurality of aviation implementation states.

18. The method of claim 16, wherein a third aviation operations program of the one or more aviation operations programs is configured in accordance with a cancelled aviation implementation state of the plurality of aviation implementation states.

19. The method of claim 16, wherein a fourth aviation operations program of the one or more aviation operations programs is configured in accordance with an inactive aviation implementation state of the plurality of aviation implementation states.

20. A computer program product comprising at least one non-transitory computer-readable storage medium having computer program code stored thereon that, in execution with at least one processor, configures the computer program product for:
identifying aviation operations program data representative of one or more aviation operations programs; configuring the one or more aviation operations programs in accordance with at least one of a plurality of aviation implementation states, wherein a first aviation operations program of the one or more aviation operations programs is configured in accordance with an armed aviation implementation state of the plurality of aviation implementation states; providing aviation mission data to an external aviation mission device; receiving, from the external aviation mission device, first program implementation data in response to an aviation mission activation event; and initiating performance of one or more aviation mission actions based on the first program implementation data.
